(19) United States
(12) Patent Application Publication
(10) Pub. No.: US 2002/0198121 A1
(43) Pub. Date: Dec. 26, 2002

(54) Composition and method for improvement of resin flow in polymer processing equipment

(76) Inventor: Normane Nitzsche, Willard, OH (US)

Correspondence Address: Woodrow W. Ban, PolyOne Corporation, 33587 Walker Road, Avon Lake, OH, 44012, US

(21) Appl. No.: 10/150,166

(22) Filed: May 17, 2002

Related U.S. Application Data
(63) Continuation-in-part of application No. 10/126,312, filed on Apr. 19, 2002.
Application No. 10/126,312 is a continuation-in-part of application No. 09/844,459, filed on Apr. 27, 2001, now Pat. No. 6,384,002.

(51) Int. Cl. C11D 1/00

(52) U.S. Cl. 510/188; 510/475

(57) ABSTRACT

A composition and method for modifying the flow characteristics of a polymeric resin utilized in polymer processing machinery. The flow modifying composition includes a functional component and a binder that is poured into the stream of a polymeric material as an additive. The method of the present invention includes feeding a mixture comprising the at least one functional component and binder component into stream of a polymeric material prior to or upon entrance into polymeric processing equipment.

### CROSS REFERENCE

This application is a continuation-in-part of prior application Ser. No. 10/126,312, filed Apr. 19, 2002, which is a continuation-in-part of prior application Ser. No. 09/844,459, filed Apr. 27, 2001, both entitled “A Composition and Method for Purging Polymer Processing Equipment.”

### FIELD OF THE INVENTION

The present invention relates to a composition for polymer processing equipment which when added to a resin or polymer can improve the flow rate as well as the moldability thereof. A method for utilizing the composition in polymer processing machinery is also disclosed. A suitable process for preparation of the composition is also described. The resin flow improving compositions contain various components which can interact with the resin or polymer and improve molding cycle times in the processing equipment and improve dimensional stability of the article or substrate molded therein.

### BACKGROUND OF THE INVENTION

Thermoplastic or thermosetting polymeric material or resin is typically processed in processing equipment, such as injection molders or extruders. The polymeric materials typically introduced or fed into the processing equipment are in a granular or pellet form which are subsequently heated above a melting point and formed into a final product. As known in the art, the polymeric materials can be colored with pigments or other colorants in order to provide the final product with a desired appearance.

Often times polymeric materials can have desirable physical or chemical properties such as modulus, stress/strain resistance, fatigue resistance, chemical resistance, etc. inherent therein, but the same can be difficult or impossible to mold in typical processing equipment utilized throughout the industry. The difficulty in processing these polymeric materials demands that manufacturers invest excessive time and monetary expenditures in order to utilize the same. While the end products may have excellent characteristics which the ultimate end user may benefit from, the manufacturing costs can make utilizing the polymeric materials prohibitive.

### SUMMARY OF THE INVENTION

The present invention provides a composition which can beneficially modify or improve the flow of a polymeric material or resin through polymer processing machinery upon being added thereto. The composition includes at least one functional component separate from the resin in a state pourable into the stream of resin as an additive. The flow modifying composition also includes a binder which binds the composition together and facilitates release of the components of the composition during processing.

The present invention also provides a method for improving the flow of a polymeric material or resin through polymer processing machinery. The method includes feeding a mixture comprising a composition of the present invention which comprises at least one functional component and a binder into a stream of polymeric material or resin in the polymer processing equipment.

### DETAILED DESCRIPTION OF THE INVENTION

A) Flow Modifying Composition

In one embodiment of the present invention, a composition is provided which can be utilized to modify or improve the flow of a polymeric resin or material through polymer processing equipment. In addition to serving as a flow modifier, the compositions of the present invention can reduce cycle times of a molding process allowing for a greater throughput of molded articles per given length of time, and can improve the dimensional stability of the final added product. Furthermore, the compositions can also function as mold release agents and provide heat stabilizing properties.

The flow improving compositions of the present invention include at least one functional additive to improve the flow of a polymeric material or resin in polymer processing equipment, typically injection molding machines which are well known in the art.

Examples of functional compounding additives or components of the present invention include microspheres, clays, nano-composites, alkylated phenols and bisphenols, alkylidene bis, tris, and polyphenols, thio and dithio bis, tris and polyalkylated phenols, phenol condensation products, amines, esters, organic phosphites and phosphates, glycerol esters, quaternary ammonium compounds, anionics, alkane sulfonate, spheriglas, antimony mercaptide, barium cadmium liquids and powders, barium cadmium zinc liquids and powders, barium calcium zinc powders and liquids, barium organic, barium powder, barium zinc liquids and powders, cadmium liquids, cadmium zinc liquids, calcium powders, calcium tin zinc pastes, liquids, and powders, calcium zinc pastes, liquids, and powders, epoxies, hydroxyl amines, leads, mixed metal soaps, phenols, phosphites, single metal soaps, tins, zinc and zinc complexes, catalysts, alcohol esters, complex esters, costabilizing lubricants, fatty acids, fatty acid amides, fatty acid esters, fatty alcohols, glycol esters, metallic stearates, aluminum, amorphous alumino silicate glass, barium, lithium, magnesium, sodium, stannous tin, amorphous and crystalline polypropylene, silicones, abietic derivatives, acetic acid derivative, azelatic acid derivatives, benzoic acid derivatives such as sodium benzoate, butene derivatives, organic fillers, urea, zinc oxide, calcium carbonate, atomite, talc, boron nitride, zinc stearate, calcium stearate, urea, zinc oxide, barium stearate, glycols, alkanolamines, oxidizing agents/peroxides, lead stearate, magnesium oxide, stearic acid, salicyclic acid, and diphenylguanidine (DPG), or a combination thereof.

Preferred functional components are microspheres, nano-composites, alumino silicate glass and benzoate salts. Microspheres are generally described as solid or hollow glass powders which comprise fused amorphous silica and inorganic oxides. The preferred microspheres are glass-based microspheres, and include, but are not limited to soda lime glass microspheres, barium titanate glass microspheres and metal-coated microspheres such as aluminum coated barium titanate glass microspheres. Suitable microspheres are available from Prizmalite of Michigan as P2015SL (soda lime glass microsphere), P2415BT (barium titanate glass microspheres), and P2453BTA (aluminum coated barium titanate glass microsphere).

A further preferred functional component is an alumino silicate glass compound which can function as a processing aid for enhancing dispersion of polymers, colorants or other components when utilized in an injection molding process. The alumino silicate glass compounds are available from Vitrolite of Irvine, Calif. as powders or a polymeric commixture with a polymer such as polyethylene.

Yet a further preferred functional component is a nano-composite or organically modified clay. The preferred clays are cationic of medium or high cation exchange capacity. The cation exchange capacity is generally reported as the number of miliequivalents of exchangeable base which can be exchanged per 100 grams of clay. The cation exchange capacity varies from about 50 to about 150 depending on the type of clay. Examples of clays which can be organically modified include sepiolite, attapulgite, montmorillonites, bentonites, saponite and nentronite, with montmorillonites being preferred. Organically modified clays are known in the art and are also described in U.S. Pat. No. 2,531,440. The preferred organically modified clays of the present invention are montmorillonite clay modified with ternary or quaternary ammonium salts. The nano-composites are commercially available from Southern Clay Products, Inc. of Gonzales, Tex. as Cloisite® NA⁺ (a natural montmorillonite), Cloisite® 93A & 30B (a natural montmorillonite modified with ternary ammonium salts), and Cloisite® 10A, 15A, 20A, and 25A (a natural montmorillonite modified with quaternary ammonium salts).

Salts of benzoic acid are also preferred functional components of the present invention. Examples include lithium benzoate and sodium benzoate. Sodium benzoate is commercially available as powders or in an extruded form from Kalama Chemical, Inc. of Seattle, Wash.

A binder component is also utilized in the flow modifying compositions of the present invention. The binder can beneficially “wet” the other components present and render them more dispersible when added with polymeric material to the processing machinery. The binder components are waxes which can be natural or synthetic. The waxes are generally solid at room temperature and have a weight average molecular weight of less than about 10,000. The binder component is present in the compositions of the invention generally in amounts greater than or equal to about 10% by weight of the composition, and generally from about 2 parts or about 5 parts to about 80 parts or 100 parts, desirably from about 8 or about 10 parts to about 50 parts or about 60 parts, and preferably from about 12 parts or 15 parts to about 30 parts or about 40 parts per 100 total parts by weight of the functional component.

Examples of waxes suitable for the binder component of the present invention include, but are not limited to, amide waxes such as ethylene bis-stearamide wax and hydroxystearamide wax, maleated ethylene waxes, maleated propylene waxes, microcrystalline waxes, oxidized waxes, castor waxes, paraffin waxes, petroleum waxes, polyethylene waxes, polytetrafluoroethylene (PTFE) waxes, wax esters, wax soaps, and polycaprolactone wax, or combinations thereof. The preferred binder component is a mixture of ethylene bis-stearamide wax and hydroxystearamide wax, at a ratio of about 60% to about 40%, respectively based on the total binder component. A further preferred binder component is a mixture of polycaprolactone wax and polyolefin wax, preferably in equal amounts, or a mixture of ethylene bis-stearamide wax, hydroxystearamide wax, polycaprolactone wax, and polyolefin wax. Suitable waxes are available from E. W. Kaufman as Cerit 220 (hydroxy stearamide wax), Rohm and Haas as Advawax® 280, and as Polycaprolactone CAPA PL1000 and CAPA 6506 Solvay Caprolactones.

The flow improving compositions of the present invention can optionally include a surfactant component such as, but not limited to, mineral oil, castor oil or soybean oil or a combination thereof. Both the surfactants and binders can aid dispersion of the functional component when added to a polymeric material. A preferred mineral oil is commercially available from Pennreco as Drakeol 34. Maxsperse W6000 is a solid surfactant available from Chemax Performance Products of Greenville, S.C. When utilized, the surfactant component is present in amounts generally from about 1 to about 40 parts, desirably from about 2 or about 3 to about 20 parts or about 30 parts, and preferably from about 5 to about 15 parts, based on 100 total parts by weight of said functional component. The flow modifying compositions are preferably free of pigment or dye.

A preferred flow modifying composition which has been found to beneficially improve the performance and/or moldability of various resins such as polypropylene and ABS is as follows. One preferred composition comprised 80 parts soda-lime glass microspheres, 10 parts of a surfactant mineral oil, and 10 parts polycaprolactone wax binder per 100 parts of the composition. The composition was prepared utilizing cold compression molding as described hereinbelow. Preferred usage levels for these flow modifying compositions are about 1 to about 3 parts per 100 parts polymeric material.

The flow modifying compositions can be used in generally any polymer processing equipment known in the art which operate at temperatures generally from about 300° F. and above, and preferably from about 400° F. to about 500° F. and above.

The flow modifying compositions of the present invention are preferably prepared utilizing a cold compression molding process as described hereinbelow and incorporated by reference. However, it is to be understood that other processes known in the art and variations of the preferred process can also be utilized. Accordingly, the flow modifying compositions of the present invention can be formed into particles, such as pellets, chips, or flakes, with pellets being preferred. The pellet sizes listed hereinbelow with regard to the purged compositions are herein incorporated by reference.

The flow modifying compositions of the present invention can be added to or melt blended with almost any known polymer, resin, or material, both thermoplastic and thermosetting. Examples of thermoplastic polymeric material with which the compositions can be used include but are not limited to ABS resins prepared from acrylonitrile, butadiene and styrene; resins prepared from acrylonitrile, butadiene, styrene and alpha methyl styrene; blends of ABS resins with other thermoplastics such as polyvinylchloride; diene resins; resins prepared from butadiene, styrene and methacrylic acid; resins prepared from acrylonitrile, butadiene, styrene and methyl methacrylate acetal copolymers; acetal resins; acrylic resins and modified acrylic resins, such as, polymethyl methacrylate, copolymers of styrene and methyl methacrylate, copolymers of methyl methacrylate and alpha methyl styrene; the cellulosic plastics, such as, cellulose acetate plastics, cellulose acetate butyrate plastics, cellulose propionate plastics, ethyl cellulose plastics and cellulose nitrate plastics; mixtures of ethyl cellulose plastics and cellulose acetate butyrate; chlorinated polyether; the fluoroplastics such as, polytetrafluoroethylene, polyvinylidene fluoride, the fluorinate ethylene-propylene plastics and the chlorotrifluoroethylene plastics; the phenoxy resins; the polybutadiene-type resins, such as, butadiene-styrene copolymer and polybutadiene; the polycarbonates; polyolefins including polypropylene and polyethylene resins, such as, low-density polyethylene; copolymers of polyethylene with other materials; chlorinated polyethylenes; chlorosulfonated polyethylenes; ethylene vinyl acetate copolymer; ethylene acrylate copolymer; polyphenylene oxide; the polysulfones; the polystyrenes; styrene copolymers; and vinyl polymers and copolymers, such as, polyvinyl chloride, a copolymer of vinyl chloride and vinyl acetate, a copolymer of vinyl chloride, a copolymer of vinyl acetate and vinyl alcohol, a copolymer of vinyl chloride and vinylidene chloride, polyvinyidichloride, and combinations thereof.

Reinforced thermoplastics can be used. The reinforcing is normally done with glass fibers, metal fibers, refractory fibers, organic fibers such as wood fibers, and other fibers.

The flow modifying compositions of the present invention are added to a polymeric material or resin in an amount generally from about 1 to about 10 parts, desirably from about 2 to about 8 parts, and preferably from about 1 to about 3 parts per 100 parts by weight of polymeric material or resin prior to or during addition of the composition into the polymer processing equipment.

B) Purge Compositions

A further embodiment of the present invention relates to a purge composition, and a method of use, that enables polymeric material or resin deposits to be removed from the inner surfaces of polymer processing equipment. The purge composition is in a concentrated form and is generally added at a desired ratio to a polymeric material or resin before or during addition to polymer processing machinery. The purge composition functions by scrubbing old resin deposits and other debris from the inner surfaces of the polymer processing machinery during a normal production cycle. Preferably, the purge composition is formulated to be most active over a temperature range that corresponds to the actual operating temperature range of the processing machinery. Numerous different formulations are described for the purge compositions. The compositions of the present invention advantageously can be utilized on machinery that is operating at low, standard, or high processing temperature ranges or anywhere therebetween.

The purging compositions of the present invention comprise various components including blowing agents, abrasives, binders, and surfactants. The compositions are preferably prepared utilizing a cold compression molding process, wherein the components such as the blowing agents are kept below temperature wherein the same would be activated or degraded.

Blowing or foaming agents are utilized in the composition of the present invention. Blowing agents can be endothermic, exothermic, or a combination thereof. The specific blowing agent utilized is selected to be active at or below the processing temperature or range of the polymeric material being processed. Typical blowing agents, when activated, evolve or produce a gas such as nitrogen or carbon dioxide. As the gas evolves, the volume of the composition-polymeric material mixture expands within the processing device, resulting in the expansion of the mixture against the inner surfaces of the machinery causing an increase in the scrubbing action of the mixture which aids in the removal of the resin deposits. In order to prevent the blowing agent from prematurely activating or decomposing, the concentrate compositions are processed and preferably formed into particles such as pellets below the activation temperature of the blowing agent.

During molding of a polymeric material and a concentrate at elevated temperatures sufficient to degrade or activate the blowing agent, endothermic blowing agents will absorb heat as they degrade. The melt flow (polymer and composition) is placed under greater pressure by the blowing agent due to the evolution of gas. Accordingly, the pressure forces the mixture against the inner surfaces of the machinery wherein the other components of the composition, especially the abrasive component can beneficially act to cleanse the process equipment.

Suitable commercially available blowing agents available from Mats Corp. Ltd. of Markham, Ontario as MS01, Cenblo Mat 100 or 500 (a carboxylic acid and carbonate based product), or Matendo P80, Uniroyal Chemical Company, Inc. of Middlebury, Conn., as Expandex® 5PT (a 5-phenyl tetrazole based product), EPI Environmental Plastics Inc. of Conroe, Tex., as EPIcor, Uniroyal Chemical Company of Middlebury, Conn., as Expandex and Reedy International Corp. of Keyport, N.J. as Safoam.

Non-limiting examples of endothermic blowing agents are polycarbonic acids, coated sodium bicarbonate, coated citric acid, coated mono sodium citrate, and coated sodium citrate. Exothermic blowing agents include, but are not limited to, azodicarbonamides, modified azodicarbonamides, oxybis (benezene sulfonyl hydrazide) (OBSH), toluenesulfonylhydrazides (TSH), 5-phenyltetrazole (5-PT), diisopropylhydrazodicarboxylate (DIHC), and dinitrosopentamethylenetetramine (DNPT).

Blowing agents in general are utilized in the purge compositions of the present invention in amounts ranging from about 5 or about 10 to about 75 or 80 parts per 100 parts by weight of the composition, with about 25 to about 50 or about 60 parts being preferred. Endothermic blowing agents are utilized in the composition of the present invention in amounts which range generally from about 5 parts to about 50, about 60, or about 70 parts, desirably from about 25 parts to about 50 or about 55 parts, and exothermic blowing agents are utilized in amounts generally from about 5 parts to about 60 parts, and desirably from about 5 parts to about 30 or about 45 parts by weight based on 100 parts by weight of the composition.

An abrasive component is also utilized in the purge compositions of the present invention. The abrasive component advantageously has properties which can wear away by scraping, rubbing and/or grinding deposited polymeric material from the inner surfaces of the polymer processing equipment, such as an extruder barrel surface or injection screw, etc. The abrasive component generally works in a physical manner by scouring. Examples of suitable abrasive components include, but are not limited to, calcium carbonate, silica, alumina, sulfates, sulfides, talc, mica, or combinations thereof. The abrasive component can contain fine, medium, or course particles, or a distribution thereof to provide an effective abrasive action.

Examples of commercially available abrasives suitable for use in the abrasive component include, but are not limited to, Omyacarb® FT (calcium carbonate) available from Omya, Inc. and calcium carbonate available from Whittaker Clark and Daniels, talc (Talc 399) available from Whittaker, Clark and Daniels, clay (Burgess KE) available from Burgess Pigment Company, and barium sulfate (2278 Blanc Fixe) available from Whittaker, Clark and Daniels.

The abrasive component is utilized in the purge compositions of the present invention in amounts generally from about 5 or about 10 parts to about 75 parts, desirably from about 20 parts to about 70 parts, and preferably from about 25 parts to about 50 parts, based on 100 parts by weight of said composition.

The purge compositions of the present invention also include a surfactant component. Surfactants are generally used in the formula to de-dust and/or densify. Examples of surfactants include, but are not limited to mineral oil, castor oil, and soybean oil. The preferred surfactant is mineral oil, such as Drakeol 34 available from Pennreco. Maxsperse W-6000 and W-3000 solid surfactants are available from Chemax Polymer Additives. The surfactants can be in either solid or liquid form.

The surfactant component is utilized in the purge compositions of the present invention in amounts generally from about 1 to about 30 parts, desirably from about 2 or about 5 to about 25 parts, and preferably from about 4 to about 8 parts, based on 100 parts by weight of said composition.

A binder component as described hereinabove is utilized in the purge compositions of the present invention. The binder component is present in the compositions of the purging invention in amounts greater than or equal to about 10% by weight, and generally from about 10 parts to about 50 parts, and preferably from about 10 parts to about 25 parts per 100 parts by weight of the purge composition.

The purge compositions of the present invention can optionally include at least one functional compounding additive component as described hereinabove including, but not limited to, nucleators, activators which lower the activation temperature of the blowing agent, plasticizers, fillers, mold release aids, processing aids, antistatic additives, and lubricants. The optional components including one or any combination of the above listed components are present in the composition in an amount generally from about 0 or 1 part to about 98 parts, desirably from about 25 parts to about 50 parts, and preferably from about 10 parts to about 20 parts by weight based on 100 parts of the total purge composition.

The purge compositions of the present invention can be used in generally any polymer processing equipment known to the art which operate at temperatures generally from about 200° F. and above, and preferably from about 250° F. to about 600 or about 700° F. The components of the purge composition are chosen to be effective at and compatible with the predetermined processing temperature.

In a first embodiment, the purge composition is optimized for purging deposits from the polymer processing equipment that is operating at low processing temperatures, such as about 400° F. or less. This first purge composition includes an endothermic blowing agent (also known as a foaming agent), an abrasive, a low melt temperature binder, and a surfactant. The formulation for this embodiment is shown in Table 1.

TABLE 1
LOW TEMPERATURE PURGE COMPOSITION FORMULATION

| | Quantity in |
|---|---|
| Purge Agent | Formula (%) |
| MSO1Genblo Mat 500 or equivalent endothermic | 50 |
| blowing agent (e.g., coated sodium bicarbonate and | |
| citric acid) | |
| Omyacarb ® FT or equivalent small particle calcium | 33 |
| carbonate | |
| Mineral Oil or equivalent surfactant | 2 |
| Cent 220 powder or equivalent hydroxy stearamide | 15 |
| wax | |
| Total | 100% |

The preferred blowing agent in the first embodiment is the commercial product MSO1 Cenblo Mat 500 available from Mats Corp. Ltd. (Markham, Ontario, L3R Canada). MSO1 Cenblo Mat 500 is a carboxylic acid and carbonate based product. However, the formulation could include any other endothermic blowing agent which results in a purge composition which may be used to purge resin deposits as desired. Alternatively, a blowing agent could be prepared as a mixture of generic ingredients, such as a mixture of generic coated sodium bicarbonate and citric acid, or the like.

The abrasive in the first embodiment adds to the scrubbing action of the purge composition and also acts as a filler. The commercial product Omyacarb® FT available from Omya Inc. (Florence, Vt.) is the preferred abrasive in the first embodiment. Omyacarb® FT is a calcium carbonate based product. However, the formulation could include any other abrasive that would increase the scrubbing action of the purge composition for the removal of resin deposits. For example, another small particle calcium carbonate having an average particle size of not greater than about 1.5 microns can be substituted for the Omyacarb® FT. Preferably, the average particle size should be about 1.3 microns, as in the Omyacarb® FT product.

The preferred binder in the first embodiment is the commercial product Cerit 220 Powder available from E.W. Kaufman (Southamper, Pa.). Cerit 220 is a hydroxystearamide based product. A hydroxystearamide wax, or any other suitable alternative, can be substituted for the Cerit 220. Whichever binder is used, it should preferably be a low melt temperature binder which will release at approximately 220° F. The melted binder aids the incorporation of the purge composition into the melt flow of the resin. The surfactant in the first embodiment is mineral oil. However, any suitable surfactant having the ability to coat or wet out the inner surfaces of the polymer processing machinery can be substituted.

In a second embodiment, the purge composition has a more effective scrubbing action at standard processing temperatures, such as within the range of about 400° F.-500° F., whereas in the first embodiment the first composition exhibits a more effective scrubbing action at lower processing temperatures. The formulation of the second purge composition includes the same abrasives and surfactants as those included in the formulation of the first purge composition. However, the second formulation differs from the first in that the endothermic blowing agent and the binder are more appropriate for use at standard processing temperatures. The formulation for this embodiment is shown in Table 2.

TABLE 2
STANDARD TEMPERATURE PURGE COMPOSITION
FORMULATION

| | Quantity in |
|---|---|
| Purge Agent | Formula (%) |
| MSO1 Cenblo Mat 100 or equivalent | 50 |
| endothermic blowing agent (e.g., coated sodium | |
| bicarbonate and citric acid) | |
| Omyacarb ® FT or equivalent small particle | 33 |
| calcium carbonate | |
| Mineral Oil or equivalent surfactant | 2 |
| Advawax ® 280 or equivalent ethylene bis | 15 |
| stearamide wax | |
| Total | 100% |

The preferred blowing agent in the second embodiment is the commercial product MSO1 Cenblo Mat 100 available from Mats Corp. Ltd. (Markham, Ontario, L3R Canada). MSO1 Cenblo Mat 100 is a carboxylic acid and carbonate based product. However, any other endothermic blowing agent could be included in the composition as long as it results in a purge formulation capable of being used to purge resin deposits as desired. For example, a blowing agent could be prepared as a mixture of generic ingredients, such as a mixture of coated sodium bicarbonate and citric acid or the like, at a ratio effective for standard processing temperatures.

The preferred binder in the standard temperature purge composition is the commercial product Advawax® 280 available from Rohm & Haas Co. (Cincinnati, Ohio). Advawax® 280 is an N,N ethylene bis(stearamide) based product. However, an ethylene bis stearamide wax, or any other suitable alternative, can be substituted. The binder should be a low melt temperature binder which will release at approximately 280° F., thereby aiding the incorporation of the purge composition into the melt flow of the stream of resin.

The ratio of endothermic blowing agent to abrasive in both the first and second purge composition formulations is optimized to achieve a maximum scrubbing action. This optimized ratio is preferably within the range from about 1.5:1 to about 2:1.

In a third embodiment, the purge composition has a more effective scrubbing action at high processing temperatures, such as about 500° F. or higher, whereas the first and second purge compositions are more effective at low and standard processing temperatures, respectively. The third composition uses the same abrasives and surfactants as those listed for the first and second compositions. However, the third composition differs from both of the previous compositions in that it preferably uses an exothermic blowing agent and a binder than are appropriate for use at high processing temperatures. The formulation for this embodiment is shown in Table 3.

TABLE 3
HIGH TEMPERATURE PURGE COMPOSITION FORMULATION

| Purge Agent | Quantity in Formula (%) |
|---|---|
| Expandex ® 5PT or equivalent exothermic | 40 |
| blowing agent (5-Phenyl tetrazole based | |
| chemistry) | |
| Omyacarb ® FT or equivalent small particle | 43 |
| calcium carbonate | |
| Mineral Oil or equivalent surfactant | 2 |
| Advawax ® 280 or equivalent ethylene bis | 15 |
| stearamide wax | |
| Total | 100% |

The preferred blowing agent in the third embodiment is the commercial product Expandex® 5PT available from Uniroyal Chemical Company, Inc. (Middlebury, Conn.). Expandex® 5PT is a 5-phenyl tetrazole based product. However, the composition could include any other exothermic blowing agent which results in a purge composition which may be used to purge resin deposits as desired. The action of the exothermic blowing agent will preferably be based on 5-Phenyltetrazole chemistry. Alternatively, other high temperature formulations might use an endothermic blowing agent, such as Mat 201 or Mat 101 (Mats Corp. Ltd., Markham, Ontario, L3R Canada), as long as the endothermic blowing agent results in a desired level of resin deposit removal at these high temperatures. Mat 201 and Mat 101 are chemical blends of polycarbonic acids, inorganic carbonates, and stearates.

In its most preferred embodiment, the formulation for the third purge composition has an optimal ratio of exothermic blowing agent to abrasive that results in maximum scrubbing action at high temperatures. This ratio is most preferably about 1:1. The average particle size of the abrasive is the same as that noted for use in the previous formulations.

The preferred binder of the high temperature purge composition is the commercially available product Advawax® 280 (Rohm & Haas Co., Cincinnati, Ohio). Advawax® 280 is an N,N ethylene bis(stearamide) based product. However, an ethylene bis stearamide wax, or any other suitable alternative, can be substituted. The binder should be a low melt temperature binder which will release at approximately 280° F.

A further example of a purge composition suitable at least for high temperature processing range is set forth in Table 4 below. An endothermic blowing agent is utilized in this formulation.

TABLE 4
HIGH TEMPERATURE PURGE COMPOSITION FORMULATION

| | |
|---|---|
| Matendo P80 (exothermic blowing agent) | 50 |
| Omyacarb ® 4 (calcium carbonate) | 19 |
| Drakeol 34 (mineral oil) | 25 |
| Advawax ® 280 (ethylene bis stearamide wax) | 6 |
| Total | 100% |

The present invention further provides a method for purging resin deposits from the processing or inner surfaces of polymer processing machinery. The method includes feeding a mixture comprised of a foaming agent, an abrasive, a surfactant, and a binder into the stream of resin in the polymer processing equipment. The mixture is poured from a container directly into a hopper of the polymer processing equipment and is added directly to the stream of resin moving through the barrel of the processing equipment. As the die and other tooling surfaces are thus cleaned in accordance with the invention, the resulting molded articles may have undesirable ingredients attributable to the purge composition Some of these articles may be recycled in the same or a compatible stream of resin.

As the purge concentrate mixes with the stream of resin, the mixture is heated as it moves along the barrel of the machinery. The binder that holds the components of the purge composition together then melts into the stream of resin, thereby releasing the individual components of the composition into the stream of resin. Incorporation of the purge composition into the melt flow is additionally aided by the presence of the melted binder.

The blowing agent begins to degrade when it reaches the appropriate elevated temperature within the processing machinery. This degradation results in the production of gas bubbles within the melt flow. As the quantity of gas increases within the resin/purge composition mixture, the volume of the mixture expands. The subsequent increase in pressure which results from the expansion of the mixture against the inner surfaces of the machinery causes an increase in the scrubbing action of the mixture which aids in the removal of resin deposits.

The abrasive component of the purge composition is released along with the blowing agent as the binder melts into the stream of resin. Additional scrubbing action is added by the abrasive to the resin mixture, and the abrasive additionally functions as sites of nucleation for the newly forming gas bubbles produced by the degradation of the blowing agent. The small size of the abrasive particles, i.e., less than 1.5 microns, increases the number of potential nucleation sites which results in a more even distribution of the gas bubbles within the melt flow. An even dispersion of the gas within the stream of resin helps to improve the scrubbing action of the purge concentrate along the inner surfaces of the processing machinery. The processing machinery containing the purge composition is operated until the molded composition exiting the machine appears clean, thereby indicating that the internal parts of the machine are clean.

As mentioned above, the normal ratio of endothermic blowing agent to filler is preferably within the range from about 1.5:1 to about 2:1. This same ratio is used for both the low and standard temperature purge compositions. However, the ratio of exothermic blowing agent to filler used in the high temperature purge composition is preferably about 1:1. These ratios are chosen based upon the amount of gas produced by the particular blowing agent employed. More specifically, the exothermic chemistry involved in the degradation of the exothermic blowing agent typically generates 3 to 5 times the amount of gas produced by the endothermic chemistry associated with the degradation of the endothermic blowing agent. Therefore, due to the greater amount of gas generated by the exothermic agent, less blowing agent is required to achieve sufficient gas production.

Typical prior art compositions are prepared or mixed at elevated temperatures in processing equipment such as extruders or two-roll mills. Conventional process equipment cannot be utilized to prepare the compositions of the present invention as the blowing agents would be prematurely activated by the relatively high temperatures. Accordingly, the compositions of the present invention are processed at temperatures less than or equal to about generally 200° F. or about 180° F., desirably less than or equal to about 160° F. and preferably less than or equal to about 140° F.

While the preferred process for blending and preferably pelletizing the purge compositions of the present invention is described hereinbelow, it is to be understood other processes known in the art and variations of the preferred process can also be utilized. The components of the composition including the abrasive and at least one blowing agent in suitable amounts, minus any liquids and low temperature melting solids, are added to and mixed in a mixer, preferably a high intensity, bowl-type mixer known in the art and available from suppliers such as the Henschel Company of Germany. The mixer can be jacketed and connected to a temperature control system. The mixer has a rotary impeller that mixes as well as agitates the ingredients. The mixing action frictionally raises the temperature of the components. As the components are mixed, the excellent dispersion is provided. When the temperature of the mixer reaches about 100° F., liquid components, if any, are added and the mixing is continued. At about 140° F. the low temperature melting solids, if any, are added to the composition and dispersed therein. The mixture is generally kept from exceeding the above stated temperatures. After a suitable period of mixing time the composition can be further processed immediately, or allowed to set at or below ambient temperature for any length of time. At this time, the composition can generally be described as granular or sand-like. The granular composition is subsequently cold compression molded into particles, preferably pellets. By cold, it is meant that no external heat source such as gas or electricity is utilized in the compression molding process. Thus, the purge composition is processed below the above stated ranges. One such compression molding device is a die and roller type pellet mill which is well known in the art and available from manufacturers such as CPM of San Francisco, Calif. as Model CL series processors. Die and roller pelletizing utilizes compaction and extrusion to produce pellets ranging in length from about 0.015 to about 1 inch, depending on the die utilized. The granular material from a supply hopper is fed continuously in a controlled stream to a pelletizing cavity. Rotation of a die in contact with the rollers cause the same to turn. The material carried by the rotation of the die is compressed between the die and the roll and forced through holes in the die. As pellets of the composition are extruded, a knife or other suitable cutting surface shears the pellets into lengths. Die sizes, and thus the pellets produced thereby may range from about 0.015 inches to about 0.250 inches in diameter with preferred sizes being about 0.0625, 0.125, and 0.150 inches. Typically pellets are formed having a length about two or three times diameter.

The purge compositions of the present invention can be added to or melt blended with also any known polymer, resin, or material, both thermoplastic and thermosetting. Examples of such resins are listed hereinabove and incorporated by reference.

An important aspect of the present invention is that the purge compositions are universal in nature and are compatible or miscible with a wide range of the above polymeric resins.

In accordance with another feature of the invention, the performance of the purge composition may be affected by the ratio of purge concentrate to resin. The purge concentrate is added to a stream of polymer, resin, etc. in an amount generally from about 1 to about 25, 50 or 100 parts, desirably from about 2 to about 20 parts, and preferably from about 3 or 4 to about 10 or 15 parts per 100 parts of resin prior to or during the purging operation. Higher amounts of purge concentrate are generally utilized when a greater level of scrubbing is required for sufficient cleaning of the machinery.

Although preferred embodiments of the invention have been shown and described, it should be understood that various modifications and substitutions, as well as rearrangements and combinations, can be made by those skilled in the art, without departing from the spirit and scope of this invention.

What is claimed is:

1. A composition for modifying the flow of a polymeric material in polymer processing machinery, said composition comprising:
at least one functional component,
a wax binder, said wax binder present in an amount from about 2 to about 100 parts having a weight average molecular weight of less than about 10,000, wherein said amounts are based on 100 total parts by weight of said functional component, and
optionally, a surfactant.

2. A composition according to claim 1, wherein said wax binder is an amide wax, a maleated ethylene wax, a maleated propylene wax, a microcrystalline wax, an oxidized wax, a paraffin wax, a petroleum wax, a polyethylene wax, a PTFE wax, a polycaprolactone wax, an ethylene bisstearamide wax, a hydroxystearamide wax, or a combination thereof.

3. A composition according to claim 2, wherein said functional component is a microsphere, a clay, a nano-composite, an alkylated phenol or bisphenol, an alkylidene bis, tris, or polyphenol, a thio or dithio bis, tris or polyalkylated phenol, a phenol condensation product, an organic phosphite or phosphate, a glycerol ester, a quaternary ammonium compound, an alkane sulfonate, an antimony mercaptide, a barium cadmium liquid or powder, a barium cadmium zinc liquid or powder, a barium calcium zinc powder or liquid, a barium zinc liquid or powder, a cadmium liquid, a cadmium zinc liquid, a calcium powder, calcium tin zinc paste, liquid, or powder, a calcium zinc paste, liquid, or powder, a hydroxyl amine, a mixed metal soap, a phenol, a phosphite, a single metal soap, a zinc or zinc complex, an alcohol ester, a complex ester, a fatty acid, a fatty acid amide, a fatty acid ester, a fatty alcohol, a glycol ester, a metallic stearate, aluminum, amorphous alumino silicate glass, barium, lithium, magnesium, sodium, stannous tin, amorphous or crystalline polypropylene, silicone, an abietic derivative, an acetic acid derivative, an azelatic acid derivative, a butene derivative, urea, zinc oxide, sodium benzoate, calcium carbonate, atomite, talc, boron nitride, zinc stearate, calcium stearate, urea, barium stearate, alkanolamine, an oxidizing agent or peroxide, lead stearate, magnesium oxide, stearic acid, salicyclic acid, and diphenylguanidine (DPG), or a combination thereof.

4. A composition according to claim 3, wherein said functional component is said microsphere, said nano-composite, said alumino silicate glass, said sodium benzoate, or a combination thereof.

5. A composition according to claim 4, wherein said wax binder component is present in an amount from about 8 parts to about 60 parts per 100 parts by weight of said functional component.

6. A composition according to claim 4, wherein said microsphere is a soda-lime glass microsphere, barium titanate glass microsphere, or aluminum coated barium titanate glass microsphere, or a combination thereof, and wherein said nano-composite is a montmorillonite clay organically modified with a ternary or quaternary ammonium salt.

7. A composition according to claim 5, wherein said wax binder is present in an amount from about 15 parts to about 25 parts per 100 parts by weight of said functional component.

8. A composition according to claim 4, wherein said surfactant is present in an amount from about 1 to about 40 parts per 100 parts by weight of said functional component.

9. A composition according to claim 8, wherein said surfactant is mineral oil, castor oil, soybean oil, or a combination thereof, and wherein said surfactant is present in an amount from about 5 to about 15 parts per 100 parts by weight of said functional component.

10. A composition according to claim 2, wherein said wax binder is said ethylene bisstearamide wax, or said hydroxystearamide wax, or a combination thereof.

11. A composition according to claim 4, wherein said composition is in a particulate form, and wherein said composition has been formed by cold compression molding.

12. A composition according to claim 11, wherein said particulate form is a pellet, chip, or flake, or a combination thereof.

13. A method for modifying flow of a polymeric material, comprising the steps of:
blending a polymeric material and a composition comprising a) a functional component, b) a wax binder, and optionally c) a surfactant, to form a mixture;
feeding said mixture into a polymer processing apparatus; and
molding an article from said mixture.

14. A method according to claim 13, wherein said wax binder is an amide wax, a maleated ethylene wax, a maleated propylene wax, a microcrystalline wax, an oxidized wax, a paraffin wax, a petroleum wax, a polyethylene wax, a PTFE wax, a polycaprolactone wax, an ethylene bisstearamide wax, a hydroxystearamide wax, and wherein said functional component is a microsphere, a clay, a nano-composite, an alkylated phenol or bisphenol, an alkylidene bis, tris, or polyphenol, a thio or dithio bis, tris or polyalkylated phenol, a phenol condensation product, an organic phosphite or phosphate, a glycerol ester, a quaternary ammonium compound, an alkane sulfonate, an antimony mercaptide, a barium cadmium liquid or powder, a barium cadmium zinc liquid or powder, a barium calcium zinc powder or liquid, a barium zinc liquid or powder, a cadmium liquid, a cadmium zinc liquid, a calcium powder, calcium tin zinc paste, liquid, or powder, a calcium zinc paste, liquid, or powder, a hydroxyl amine, a mixed metal soap, a phenol, a phosphite, a single metal soap, a zinc or zinc complex, an alcohol ester, a complex ester, a fatty acid, a fatty acid amide, a fatty acid ester, a fatty alcohol, a glycol ester, a metallic stearate, aluminum, amorphous alumino silicate glass, barium, lithium, magnesium, sodium, stannous tin, amorphous or crystalline polypropylene, silicone, an abietic derivative, an acetic acid derivative, an azelatic acid derivative, a butene derivative, urea, zinc oxide, sodium benzoate, calcium carbonate, atomite, talc, boron nitride, zinc stearate, calcium stearate, urea, barium stearate, alkanolamine, an oxidizing agent or peroxide, lead stearate, magnesium oxide, stearic acid, salicyclic acid, and diphenylguanidine (DPG), or a combination thereof.

15. A method according to claim 14, wherein said functional component is said microsphere, said nano-composite, said alumino silicate glass, said sodium benzoate, and wherein said wax binder component is present in an amount from about 8 parts to about 60 parts per 100 parts by weight of said functional component.

16. A method according to claim 15, wherein said microsphere is a soda-lime glass microsphere, barium titanate glass microsphere, or aluminum coated barium titanate glass microsphere, or a combination thereof, and wherein said nano-composite is a montmorillonite clay organically modified with a ternary or quaternary ammonium salt and wherein said wax binder is present in an amount from about 15 parts to about 25 parts per 100 parts by weight of said functional component.

17. A method according to claim 16, wherein said surfactant is present in an amount from about 1 to about 40 parts per 100 parts by weight of said functional component.

18. A method according to claim 17, wherein said surfactant is mineral oil, castor oil, soybean oil, or a combination thereof, and wherein said surfactant is present in an amount from about 5 to about 15 parts per 100 parts by weight of said functional component.

19. A method according to claim 18, wherein said wax binder is said ethylene bisstearamide wax, or said hydroxystearamide wax, or a combination thereof.

20. A method according to claim 19, wherein said composition has been formed by cold compression molding and is a pellet, chip, or flake or a combination thereof.
